(19) United States
(12) Patent Application Publication
(10) Pub. No.: US 2024/0017811 A1
(43) Pub. Date: Jan. 18, 2024

(54) VACUUM AIRSHIP

(71) Applicant: Ilia TOLI, San Jose, CA (US)

(72) Inventor: Ilia TOLI, San Jose, CA (US)

(21) Appl. No.: 17/866,472

(22) Filed: Jul. 16, 2022

(51) Int. Cl. B64B 1/14; B64B 1/08

(52) U.S. Cl. CPC B64B 1/14; B64B 1/08

(57) ABSTRACT

A vacuum airship includes an envelope and means for creating and controlling vacuum pressure within the envelope. The envelope includes skin and a frame for supporting the skin such that the frame is under compression and the skin is in tension during operation of the airship. The frame includes a plurality of rigid tube-like frame elements.

### FIELD

The present technology is in the field of airborne platforms and, more specifically, airships.

### BACKGROUND

A vacuum airship is a hypothetical airship that is evacuated rather than filled with a lighter-than-air gas, such as hydrogen or helium. By eliminating the mass of hydrogen or helium, a vacuum airship has the potential to provide far greater lifting power per volume of air displaced. Therefore, was is needed is a vacuum airship that includes an envelope and a means for controlling a vacuum within an envelope.

### SUMMARY

In accordance with various embodiments and aspects herein, a vacuum airship includes an envelope and means for creating and controlling a vacuum (or vacuum level) within the envelope. The envelope is defined by and includes skin and a frame for supporting the skin, such that the frame is under compression and the skin is in tension during operation of the airship. The frame includes a plurality of rigid tube-like frame elements.

### BRIEF DESCRIPTION OF THE DRAWINGS

In order to understand the vacuum airship herein more fully, reference is made to the accompanying drawings. The vacuum airship is described in accordance with the aspects and embodiments in the following description with reference to the drawings or figures, in which like numbers represent the same or similar elements. Understanding that these drawings are not to be considered limitations in the claimed scope of the vacuum airship, the presently described aspects and embodiments of the vacuum airship are described with additional detail through use of the accompanying drawings.

FIG. 1 is an illustration of various components of a vacuum airship, including an envelope, in accordance with the various aspects and embodiments of the invention.

FIG. 2 is an illustration of a method of operating the vacuum airship of FIG. 1 in accordance with the various aspects and embodiments of the invention.

FIG. 3 is an illustration of an example of the envelope in accordance with the various aspects and embodiments of the invention.

FIG. 4 is an illustration of a cross section of the envelope of FIG. 3 in accordance with the various aspects and embodiments of the invention.

FIG. 5 is an illustration of a structure for binding skin to a frame of the envelope of FIG. 3 in accordance with the various aspects and embodiments of the invention.

FIG. 6 is an illustration of tensioned skin of the envelope of FIG. 3 in accordance with the various aspects and embodiments of the invention.

FIG. 7 is an illustration another example of the envelope in accordance with the various aspects and embodiments of the invention.

FIG. 8 is an illustration of another example of the envelope in accordance with the various aspects and embodiments of the invention.

FIG. 9 is an illustration of another envelope in accordance with the various aspects and embodiments of the invention.

FIG. 10 is an illustration of another envelope in accordance with the various aspects and embodiments of the invention.

### DETAILED DESCRIPTION

The following describes various examples of the present technology that illustrate various aspects and embodiments herein. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various aspects and embodiments,” “various embodiments,” or similar language means that a particular aspect, feature, structure, or characteristic described in connection with the embodiment is included in at least one embodiment herein. Thus, appearances of the phrases “in one embodiment,” “in at least one embodiment,” “in an aspect and embodiment,” “in certain embodiments,” and similar language throughout this specification may, but do not necessarily, all refer to the same embodiment or similar embodiments. Furthermore, aspects and embodiments described herein are merely exemplary, and should not be construed as limiting of the scope or spirit of the claims as appreciated by those of ordinary skill in the art.

Furthermore, to the extent that the terms “including”, “includes”, “having”, “has”, “with”, or variants thereof are used in either the detailed description and the claims, such terms are intended to be inclusive in a similar manner to the term “comprising.”

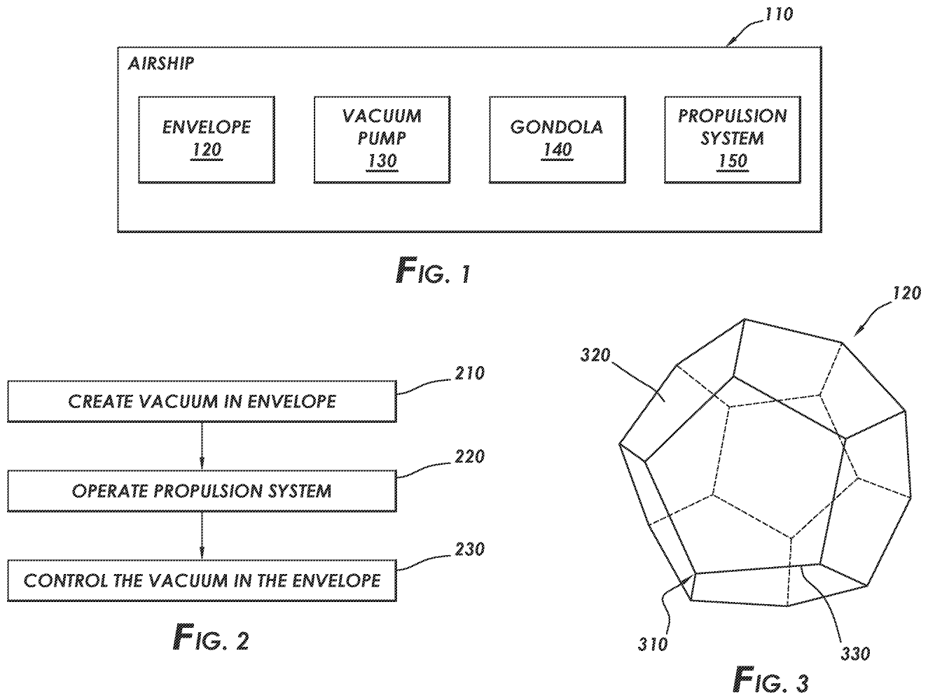

Referring now to FIG. 1, a vacuum airship 110 includes an envelope 120 and a vacuum pump 130 for creating and controlling a vacuum, vacuum pressure, and/or vacuum level (near-vacuum) within the envelope 120 in accordance with the various aspects and embodiments of the invention. Vacuum (vacuum level or vacuum pressure) is any pressure that is lower than atmospheric pressure in a known volume; atmospheric pressure is the datum point of vacuum as well as the available pressure the vacuum has to offer. Thus, vacuum is a pressure that can be measured. There are pressure measurements specific to vacuum and a defined known volume is used to determine a vacuum state. The volume, defined by the envelop disclosed herein, is a specific space in which vacuum can be considered and measured.

The envelope 120 may have a substantially outer shape of a Platonic solid. As used herein, a Platonic solid refers to a convex, regular polyhedron in three-dimensional Euclidean space. Faces of the Platonic solid are congruent (identical in shape and size) regular polygons, and the same number of faces meet at each vertex.

The envelope 120 includes a rigid frame that defines edges of the Platonic solid, and an airtight skin that defines faces of the Platonic solid. The skin is supported by the frame in accordance with the various aspects and embodiments of the invention. The skin surrounds the frame in accordance with the various aspects and embodiments of the invention. Examples of the envelope 120 are described below.

The vacuum airship 110 may further include a gondola 140 and a propulsion system 150 coupled to the envelope 120. The gondola 140 may be an external equipment or passenger compartment that s attached to the envelope 120.

The propulsion system 150 may include one or more propulsion engines that are carried in the gondola 140 or placed in separate nacelles. The nacelles may be mounted to the envelope 120. The vacuum airship 110 may also include flight control surfaces (not shown) for adjusting attitude of the vacuum airship 110 during flight.

The vacuum airship 110 may be configured for any number of applications. Examples include, but are not limited to, an urban vertical takeoff and landing (VTOL) vehicle (e.g., a taxi), an air crane for loading and unloading cargo in seaports and railway stations, a vehicle for moving cargo across land and sea, a truck for moving cargo, a high-altitude spacecraft launch vehicle.

Reference is made to FIG. 2, which illustrates the basic operation of the vacuum airship 110 in accordance with the various aspects and embodiments of the invention. At block 210, the vacuum pump 130 is operated to create a vacuum in the envelope 120. As used herein, the term vacuum does not refer to a volume that is devoid of air. Rather, a vacuum as used herein refers to air pressure below atmospheric pressure.

As used herein buoyant force refers to an upward force that at is proportional to the weight of air displaced from the envelope 120. The buoyant force increases as air is removed from the envelope 120. As used herein, lift or lift capability of the airship 100 is equal to the buoyant force minus the weight of the airship 100.

At block 220, the propulsion system 150 is operated. Force generated by the propulsion system 150, in combination with the buoyant force generated by the envelope 120, moves the vacuum airship 110 in a desired direction.

At block 230, the vacuum within the envelope 120 is controlled. The vacuum pump 130 may remove air from the envelope 120 to compensate for any air leakage into the envelope 120. During ascent, the vacuum pump 130 may remove additional air from the envelope 120 to increase the buoyant force. During descent, air may be allowed to enter the envelope 120 to reduce the buoyant force. Entry of the air may be allowed by the vacuum pump 130 and/or by one or more valves (not shown).

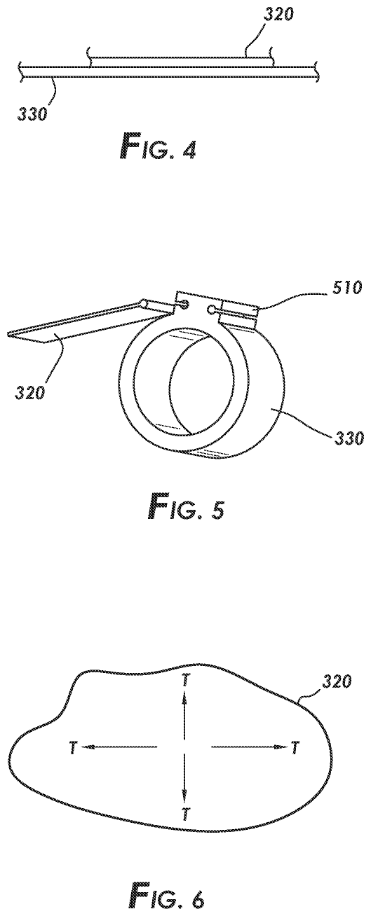

Reference is now made to FIG. 3, which illustrates an example of the envelope 120. In this example, the envelope 120 has the outer shape of a dodecahedron. The dodecahedron envelope 120 has twelve faces, twenty vertices, and thirty edges.

The dodecahedron envelope 120 has a rigid frame 310 and skin 320. The frame 310 defines the edges of the dodecahedron envelope 120. The frame 310 may include a plurality of individual frame elements 330, where each frame element 330 is located at an edge of the dodecahedron envelope 120 and extends between two vertices. The frame 310 is preferably made of a lightweight material that is strong in compression, such as titanium.

The skin 320 is airtight, and it defines the faces of the dodecahedron envelope 120. The skin is supported by the frame 310.

Additional reference is made to FIG. 4, which illustrates a cross-section of the dodecahedron envelope 120. The frame elements 330 are tube-like. Cross-section of the frame elements 330 may be circular, rectangular, or other suitable non-cylindrical geometry in accordance with the various aspects and embodiments of the invention. The frame elements 330 may be solid or they may be hollow.

The skin 320 is made of a thin sheet of a material that is strong in tension. A better ratio of (tensile strength)/density is preferred. For example, thin-gauged steel sheets or sheets of a composite such as Kevlar may be used. If the skin material is not airtight, it can be made airtight with an outer coating of a plastic material.

In some configurations, the skin 320 is not bound to any of the elements 330 of the frame. In other configurations, the skin 320 may be bound to the frame 310 at a single location, such as where the gondola 140 attaches to the envelope 120.

Additional reference is made to FIG. 5, which illustrates an example of a structure 510 for binding the skin 320 to a frame element 330 in accordance with the various aspects and embodiments of the invention. This structure 510 may be used In configurations where the skin 320 is bound to the frame 310 at only a single location.

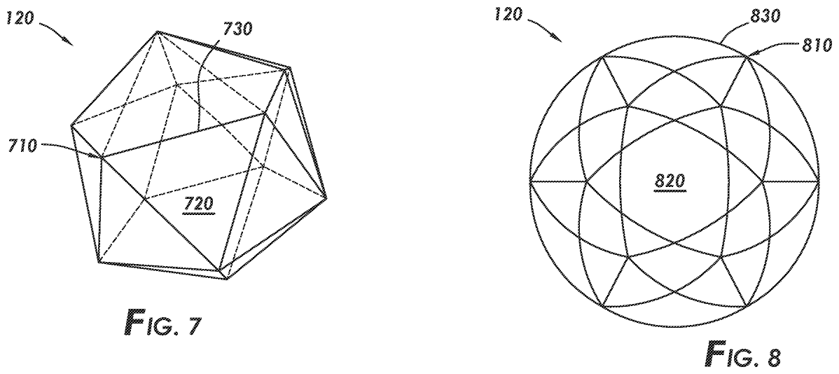

Additional reference is made to FIG. 6. The skin 320 may be pre-tensioned, for instance by stretching it over the frame 310. The pre-tensioning enables thinner materials for the skin (e.g., steel sheet) to be used.

During operation of the airship 110, there is a substantial pressure differential between atmospheric pressure (outside the envelope 120) and vacuum pressure (inside the envelope 120). This pressure differential places the frame 310 under compression. It also causes the skin 320 to dimple and to be placed in tension. The dimpling might have the effect of reducing damping from air friction.

The size of the envelope 120 depends in part on the intended lift requirements. For instance, an envelope 120 in the range of ten (10) to twelve (12) meters would be sufficient for VTOL vehicle carrying four people.

The vacuum airship 110 is not limited to the examples described above. The geometry of the envelope 120 is not limited to a dodecahedron. For example, the envelope 120 may have the geometry of an icosahedron.

Reference is now made to FIG. 7, which illustrates an icosahedron envelope 120 in accordance with the various aspects and embodiments of the invention. The icosahedron envelope 120 has twenty faces, twelve vertices, and thirty edges. A frame 710 defines the edges, with each frame element 730 located at an edge 730 of the icosahedron envelope 120 and extending between two vertices. Skin 720 defines the faces of the icosahedron envelope 120.

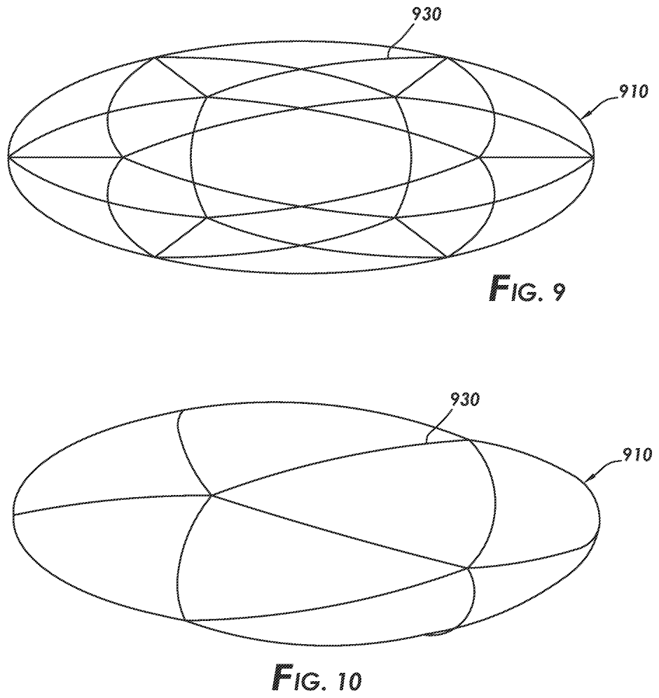

Reference is now made to FIG. 8, which illustrates an envelope 120 that is not a Platonic solid in accordance with the various aspects and embodiments of the invention. The envelope 120 of FIG. 8 has the geometry of an icosa-ball. Consider an icosahedron and a circumscribed sphere. As used herein, the term icosa-ball refers to the radial projection of the edges of the icosahedron from its center to the circumscribed sphere The icosa-ball envelope 120 has twenty faces, twelve vertices, and thirty edges. A frame 810 defines the edges. Each element 830 of the frame 810 is arcuate, is located at an edge of the icosa-ball envelope 120, and extends between two vertices. Skin 820 is stretched over the frame 810 to define curved faces of the icosa-ball envelope 120.

Reference is now made to FIGS. 9 and 10, which illustrate that the envelope 120 is not limited to any particular geometry. FIG. 9 shows the frame 910 of an envelope 120 having the shape of an icosa-dirigible, and FIG. 10 is a transverse cross-sectional view of the frame 910. As used herein, the term icosa-dirigible refers to an icosa-ball that has been stretched along one or more axis. Each element 930 of the frame 910 is arcuate, and skin (not shown) covers the frame 910. Because each frame element 930 is curved, each face of the icosa-dirigible is also curved (as opposed to being flat).

In each of these examples, the skin is sufficiently large so as not to be torn by the structural strain of the frame. This in turn increases the surface area exposed to the atmosphere and the force borne by the frame.

In those configurations where the skin is not bound to the frame, there is not a problem of tearing of the skin under frame stress.

Not all elements of the frame need be equally thick. Thickness will be dictated by the structural loads placed on the frame elements. Main sources of the structural loads include buoyancy, atmospheric pressure, and useful mass that is being transported (for instance, by the gondola 140). Lesser sources of the structural loads include mass of the frame and the skin, and wind. In configurations where the gondola 140 is suspended from the envelope, those frame elements supporting the gondola 140 will be thicker because they carry the buoyancy and useful mass loads.

Means for creating and controlling a vacuum in the envelope is not limited to the vacuum pump 130. The vacuum pump 130 is but one example. As a second example of such means, a second, inner skin, much thinner and more versatile, may be installed inside the frame to vary the volume of the envelope 120. To increase the vacuum within the envelope 120, this second skin is partially or totally pulled out. To reduce the vacuum, the second skin is pulled in.

As a third example, an umbrella-like structure can be used instead of the second skin. Closing the umbrella-like structure forces air out of the envelope 120 to decrease the volume to zero, and then opening the umbrella-like structure creates the evacuated envelope 120.

Certain examples have been described herein and it will be noted that different combinations of different components from different examples may be possible. Salient features are presented to better explain examples; however, it is clear that certain features may be added, modified, and/or omitted without modifying the functional aspects of these examples as described. Practitioners skilled in the art will recognize many modifications and variations. The modifications and variations include any relevant combination of the disclosed features. Descriptions herein reciting principles, aspects, and embodiments encompass both structural and functional equivalents thereof.

It will be appreciated by those skilled in the art that other various modifications could be made to the device without parting from the spirit and scope of this disclosure (especially various programmable features and architecture). All such modifications and changes fall within the scope of the claims and are intended to be covered thereby.

The scope of the invention, therefore, is not intended to be limited to the exemplary embodiments and aspects that are shown and described herein. Rather, the scope and spirit of the invention is embodied by the appended claims.

1. A vacuum airship comprising:
an envelope having a substantially outer shape of a Platonic solid; and
means for creating and controlling a vacuum within the envelope, where the envelope includes:
a rigid frame that defines edges of the Platonic solid; and
an airtight skin that defines faces of the Platonic solid, the skin being supported by the frame.

2. The vacuum airship of claim 1, wherein the skin is stretched over the frame.

3. The vacuum airship of claim 1, wherein the Platonic solid is a dodecahedron.

4. The vacuum airship of claim 1, wherein the Platonic solid is an icosahedron.

5. The vacuum airship of claim 1, wherein elements of the frame are tube-like.

6. The vacuum airship of claim 1, wherein the skin is not bound to the frame.

7. The vacuum airship of claim 1, wherein the skin is bound to the frame at only a single location of the frame.

8. The vacuum airship of claim 1, wherein the means includes an air vacuum.

9. The vacuum airship of claim 1 further comprising a gondola and a propulsion system coupled to the envelope.

10. An envelope for a vacuum airship, the envelope comprising:
a rigid frame that defines edges of a Platonic solid; and
an airtight skin that defines faces of the Platonic solid, the skin surrounding the frame.

11. The envelope of claim 10, wherein the skin is stretched over the frame.

12. The envelope of claim 10, wherein the Platonic solid is a dodecahedron.

13. The envelope of claim 10, wherein the Platonic solid is an icosahedron.

14. The envelope of claim 10, wherein the skin is bound to the frame.

15. The envelope of claim 10, wherein the skin is bound to the frame at only a single location of the frame.

16. A vacuum airship comprising:
an envelope including:
a skin; and
a frame including a plurality of rigid tube-like frame elements,
wherein the frame supports the skin such that the frame is under compression and the skin is in tension during operation of the airship; and
means for controlling vacuum pressure within the envelope.

17. The vacuum airship of claim 16, wherein the envelope has the shape of a dodecahedron and wherein edges of the dodecahedron are defined by the frame, and faces of the dodecahedron are defined by the skin.

18. The vacuum airship of claim 16, wherein the envelope has the shape of an icosahedron and wherein edges of the icosahedron are defined by the frame and faces of the icosahedron are defined by the skin.

19. The vacuum airship of claim 16, wherein the envelope has the shape of an icosa-ball.

20. The vacuum airship of claim 16, wherein the envelope has the shape of an icosa-dirigible.
